(19) United States
(12) Patent Application Publication
(10) Pub. No.: US 2017/0282754 A1
(43) Pub. Date: Oct. 5, 2017

(54) VEHICLE SEAT ASSEMBLY AND METHOD OF STORAGE

(71) Applicants: Winsen C. ZOUZAL, (US); LEAR CORPORATION, Southfield, MI (US)

(72) Inventors: Winsen C. ZOUZAL, Detroit, MI (US); Gerald PATRICK, Shelby Township, MI (US); Michael R. Powell, Waterford, MI (US); Samuel Hanlon, Livonia, MI (US)

(21) Appl. No.: 15/085,542

(22) Filed: Mar. 30, 2016

(51) Int. Cl. B60N 2/02; B60N 2/30

(52) U.S. Cl. CPC B60N 2/0244; B60N 2/3011; B60N 2/305; B60N 2002/0268

(57) ABSTRACT

A vehicle seat assembly and controller are provided. The assembly includes a front seat having a front seat bottom and a front seat back mounted adjacent to the front seat bottom. A sensor cooperates with at least one of the front seat bottom and the front seat back. An actuator is disposed on at least one of the seat bottom and seat back. A rear seat assembly is behind the front seat assembly. The vehicle seat controller is in communication with the sensor and the actuator. The controller receives an input indicative of a request to move a rear seat assembly to a storage position. The controller conveys a signal to an actuator to move a front seat assembly to an accommodation position in response to the input.

### TECHNICAL FIELD

Various embodiments relate to adjustable seat assemblies.

### BACKGROUND

An adjustable seat assembly is illustrated and described in U.S. Pat. No. 9,145,078, which issued on Sep. 29, 2015 to Lear Corporation.

### SUMMARY

According to at least one embodiment, a vehicle seating assembly and a vehicle seat controller are provided. The vehicle seating assembly includes a front seat assembly having a front seat bottom mounted to the vehicle body and a front seat back mounted to the vehicle body adjacent to the front seat bottom. A sensor cooperates with at least one of the front seat bottom and the front seat back. An actuator is disposed on at least one of the seat bottom and seat back. A rear seat assembly is positioned behind the front seat assembly and is movable to a storage position. The rear seat assembly includes a rear seat bottom pivotally mounted to the vehicle body and a rear seat back mounted to move relative to the rear seat bottom. The vehicle seat controller is in communication with the sensor and the actuator and is programmed to receive a request to move a rear seat to a storage position. A current storage space is determined based on a position of a front seat. A requested storage space is determined based on the storage position. The controller provides a signal to the actuator to move at least one of the front seat assembly and the rear seat assembly to an accommodation position when the requested storage space is less than the current storage space.

In another embodiment, the storage position includes folding a rear seat back toward a rear seat bottom to a folded storage position.

In a further embodiment, the storage position includes pivoting the rear seat bottom in relation to the vehicle body to move the rear seat assembly from the folded storage position to a tumbled storage position.

In another embodiment, the front seat assembly moves to a first accommodation position when the rear seat assembly is requested to move to the folded position. And the front seat assembly moves to a second accommodation position when the rear seat assembly is requested to move to the tumbled position.

In yet another embodiment, the accommodation position decreases at least one of a relined angle of the front seat back and a fore-aft position of the front seat bottom to increase the current storage space.

In still another embodiment, the accommodation position rotates a rear head restraint toward the rear seatback to decrease the requested storage space.

In one other embodiment, the vehicle seat assembly also includes an interface in communication with the controller for inputting the requested storage position.

In another embodiment, the interface comprises at least one switch disposed adjacent a tailgate of the vehicle.

According to at least one other embodiment, a vehicle seat assembly and controller are provided. The assembly includes a front seat having a front seat bottom and a front seat back mounted adjacent to the front seat bottom. A sensor cooperates with at least one of the front seat bottom and the front seat back. An actuator is disposed on at least one of the seat bottom and seat back. A rear seat assembly is behind the front seat assembly. The vehicle seat controller is in communication with the sensor and the actuator. The controller receives an input indicative of a request to move a rear seat assembly to a storage position. The controller conveys a signal to an actuator to move a front seat assembly to an accommodation position in response to the input.

In another embodiment, the vehicle seat assembly also includes a rear seat actuator for moving the rear seat assembly to the storage position after the front seat assembly is moved to the accommodation position.

According to at least one embodiment, a method for controlling a seat assembly is provided. The seat assembly includes a front seat and a rear seat positioned rearward of the front seat. The method includes receiving a first input indicating a requested storage position of a rear seat. A first actuator is commanded to move at least one of the front seat and rear seat to an accommodation position in response to the first input. A second actuator is commanded to move the rear seat to the storage position after one of the front seat and rear seat is moved to the accommodation position.

In another embodiment, the method also includes receiving a second input indicating a position of the front seat. A requested storage space is determined based on the second input. A current storage space is determined based on the second input. The first actuator is commanded to move at least one of the front seat and rear seat to the accommodation position when the requested storage space is less than the current storage space.

In still another embodiment, the method also includes moving the front seat to the accommodation position by decreasing at least one of a relined angle of a front seat back and a fore-aft position of a front seat bottom to increase the current storage space.

In yet another embodiment, the method also includes moving the front seat to the accommodation position by rotating a rear head restraint toward a rear seat back to decrease the requested storage space.

In another embodiment, the method also includes notifying a front seat occupant before moving the front seat to the accommodation position.

### BRIEF DESCRIPTION OF THE DRAWINGS

FIG. 1 is a schematic illustration of a vehicle seat assembly according to an embodiment.

FIG. 2 is a schematic illustration of a vehicle seat assembly of FIG. 1 where the rear seat assembly is further illustrated in a folded position.

FIG. 3 is a schematic illustration of a vehicle seat assembly of FIG. 1 where the rear seat assembly is further illustrated in a tumbled position.

FIG. 4 is a flow chart illustration of a method of controlling the vehicle seat assembly of FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

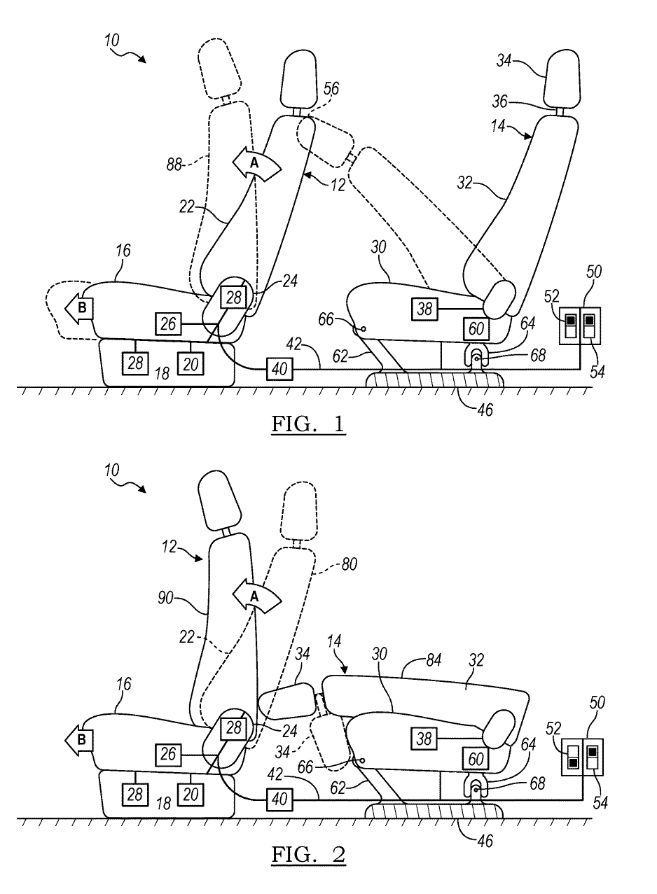

Referring now to FIG. 1, a vehicle seat assembly is illustrated according to an embodiment and is referenced generally by numeral 10. The vehicle seat assembly 10 is adapted to be mounted to a vehicle body, as is known in the art. The vehicle seat assembly 10 may be installed in any vehicle, for example a land vehicle, such as an automobile. The vehicle seat assembly 10 includes a front seat assembly 12 and a rear seat assembly 14 positioned rearward of the front seat assembly 12, both adapted to be mounted to a vehicle body. The front and rear seat assemblies 12, 14 may be a driver's side seat or a passenger side seat.

The first row seat 12 includes a seat bottom 16 that is adapted to be adjustably mounted in the vehicle along a seating rail or frame 18. The seat bottom 16 and frame 18 may include mounting hardware with fore/aft adjustment, as is known in the art. As such, the seat bottom 16 may be translated along arrow A in the fore-aft direction. An actuator 20 is provided for moving the seat bottom 16 in the fore-aft direction.

The front seat assembly 12 also includes a seat back 22 which is adapted to be pivotally connected to the vehicle body adjacent to the seat bottom 16, as is known in the art. The seat back 22 may be pivotally connected to the seat bottom 16 by a recline mechanism 24, which is also known in the art. Alternatively, the seat back 22 could be pivotally connected to the vehicle body via the recline mechanism 24. For example, the seat back 22 may be pivoted in the direction of arrow B. The seat back 22 is pivotally adjustable to at least two positions, an upright or reclined position depicted position, where the seat back 22 is pivoted rearward of the upright position at a reclined angle. Of course, the seat back 22 may be positioned in multiple reclined positions at various reclined angles rearward of the upright position based on the occupant's preferred seated position. The seat back 22 may also be pivoted forward of the upright position to a non-use position, or stowed position. An actuator 26 is provided for pivoting the seat back 22 to the various reclined angles.

The front seat assembly 12 may also be provided with sensors 28 to detect the seat position. The sensors 28 may be provided on the front seat bottom 16 for detecting the fore-aft position of the seat bottom 16. A sensor 28 can also be provided on the seat back 22 for detecting the reclined position of the seat back 22.

The seating assembly 10 also includes the rear seat 14. As shown in FIG. 1, the rear seat 14 is a second row seat, but the seat assembly 10 may have any number of rows. The rear seat 14 includes a seat bottom 30 adapted to be operably connected to a vehicle body for adjustment to between at least an upright and a stored position. The rear seat 14 also includes a seat back 32 operably connected to the vehicle body adjacent to the seat bottom 30 for adjustment to an upright position and a storage position with a folding actuator 38.

The recliner actuator 38 has a locked state, in which the seat back 32 is inhibited from pivoting relative to the seat bottom 30, and an unlocked or released state, in which the seat back 32 may be pivoted relative to the seat bottom 30 between one or more use positions and a folded position. For example, FIG. 1 shows the seat back 32 locked in a substantially upright use position, and FIG. 2 shows the seat back 32 in a folded position in which the seat back 32 is generally horizontally disposed relative to the floor 46.

A head restraint 34 is supported upon the seat back 32. The head restraint 34 may be mounted to a pair of posts 36 extending from the seat back 32 for supporting the head restraint 34, and optionally providing height adjustment. The head restraint 34 is also pivotally connected to the seat back 32 for stowing or folding the head restraint 34 when the rear seat 14 is folded and stored.

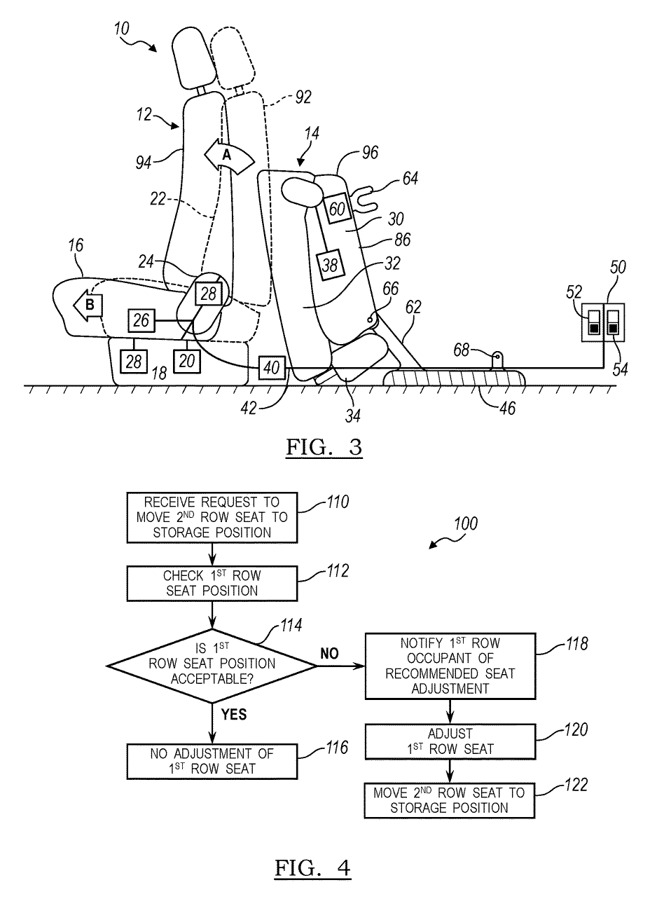

The rear seat assembly 12 may also include a tumble actuator 60 to allow the seat bottom 30 to be pivoted to the tumbled storage position shown in FIG. 3. The tumble actuator 60 includes one or more latches 64, such as floor latches, that are configured to releasably couple the rear seat assembly 14 to the floor 46 of the vehicle body. The floor latches 64 are coupled with the seat bottom 30 and are each engageable with an engaging member, such as a striker 68, that is attached to the floor 46 of the vehicle body. When the tumble actuator 60 is activated, the actuator causes the latches 64 to be released or unlatched from the floor 46. Once the latches are released, the rear seat assembly 14 may be tumbled or stowed. In the tumbled position, the seat bottom 30 and seat back 32 may pivot relative to the floor 46 about a pivot axis 66, which may extend through a tumble pivot mount 62 on the seat bottom 30, for example.

As the folding actuator 38 and the tumble actuator 60 are activated, the rear seat assembly 14 may then automatically pivot forward about the pivot axis 66 to the tumbled position, illustrated in FIG. 3, by means of springs (not shown) or gas-charged struts (not shown) acting on the seat bottom 30, for example.

A vehicle seat controller 40 may also be provided in the seat assembly 10, or as separate controllers in each of the front and rear seat assemblies 12, 14. Alternatively, the seat controller 40 may be provided as a kernel in a vehicle controller. The seat controller 40 is in communication the front seat assembly 12, including the sensors 28, the seat bottom actuator 20 and the seat back actuator 26. The controller 40 is also in communication with the rear seat assembly 14, including the folding actuator 38 and the tumble actuator 60. The sensors and actuators are connected to a wire harness 42 for conveying communication signals from the controller 40 and the front seat assembly 12 or rear seat assembly 14, or vice versa.

The rear seat assembly 14 is connected to a fold and tumble interface 50 that allows a user to indicate the desire to move the rear seat assembly 14 to the folded position or the tumbled position. The fold and tumble interface 50 is also in communication with the seat assembly 10 and the seat controller 40. The fold and tumble interface 50 may include a vehicle switches 52, 54 located in the vehicle. The vehicle switches may include a fold switch 52 indicating the users desire to fold the rear seat assembly 14. The vehicle switches may also include a tumble switch 54 indicating the users desire to tumble and store the rear seat assembly 14. The vehicle switch 52, 54 may be located on the rear seat assembly 14. Alternatively, the vehicle switches 52, 54 may be positioned remotely from the rear seat assembly 14 in the vehicle in a rear cargo area so that the vehicle switch is accessible from the rear tailgate area of the vehicle. The interface 50 and/or switches 52, 54 may also be integrated an instrument panel display or any suitable location.

The interface 50 may also be remote from the vehicle, such as a personal digital assistant (PDA) including phones, tablets and the like. The interface 50 may be provided as a smart phone application, wherein users enter the desire to move the rear seat assembly 14 to the folded position or the tumbled position. The smart phone interface may not require on-site expertise or seat properties. The interface 50 may be wired or wireless communication with the seat controller 40.

In some vehicles, if the front seat assembly 12 is adjusted more rearward in the vehicle and the seat back 22 is in a more reclined position, interference 56 between the front seat assembly 12 and rear seat assembly 14 can occur when the rear seat assembly tries to move to the folded position, as shown in FIG. 1. The interference 56 between the front seat assembly 12 and rear seat assembly 14 can prevent the rear seat assembly 14 from being able to be stored through the proper fold and tumble operations. As shown in FIG. 1, the fore-aft and reclined positions of the front seat assembly 12 creates the interference 56 that does not allow the rear seat assembly to fold flat so that the seat bottom 30 is generally parallel to the seat back 32. Even if the position of the front seat assembly 12 is adjusted to allow the rear seat assembly 14 to fold flat, the position of the front seat assembly 12 may still not allow the rear seat assembly 14 to pivot to the tumbled position.

FIG. 2 illustrates a seating configuration where the seat assembly 10 is moved to allow the rear seat assembly 14 to fold the seat back 32 flat to be generally parallel with seat bottom 30 in a folded position 84. To prevent interference while moving the rear seat assembly 14 to the folded position 84, the seat back 22 of the front seat assembly 12 is moved from a reclined position 80 to an upright position 90. In the upright position 90, the angle of recline of the seat back 22 is decreased along the direction of arrow A.

FIG. 3 illustrates another seating configuration where the seat assembly 10 is moved to allow the rear seat assembly 14 to pivot for greater storage to a tumble position 96. To prevent interference while moving the rear seat assembly 14 to the tumble position 96, the front seat assembly 12 is moved from a rearward position 92 to a forward position 94 along the fore-aft direction of arrow B. As shown, by moving the seat bottom 16 forward, the seat back 22 is similarly moved in the fore-aft direction B. The seat back 22 may also be moved from a reclined position 80 to an upright position 90 to provide more space to allow the rear seat assembly 14 to move to the tumble position 96. Of course, any combination of moving the seat back 22 in the direction A and moving the seat bottom 16 in the direction B may be utilized to provide a seating configuration that allows for storage of the rear seat assembly 14 while maintaining comfort and space recommendations for the front seat assembly 12.

In some applications, the rear seat assembly 14 may be moveable to a third storage position where the rear seat assembly 14 rotates past the tumble position 96 to a further rotation position where an underside 86 of the seat bottom 30 is facing upward. In some applications, the further rotation position allows the rear seat assembly 14 to be moved into a storage compartment in the vehicle so that the underside 86 of the seat bottom 30 is generally coplanar with the floor 46, or at least a portion of the seat back 32 and seat bottom 30 are disposed below the floor 46.

FIG. 4 illustrates a method 100 of controlling the seat assembly 10 to allow the fold and tumble of the rear seat assembly 14 when requested. In block 110, the seat controller 40 receives a request to move the rear seat assembly 14 to a folded position or a tumbled position. The request may input via the interface 50 such as the vehicle switches 52, 54. Based on the fold and tumble request input, the seat controller 40 determines the amount of storage space required by the rear seat assembly 14. The storage space may include the amount of space need for the rear seat assembly 14 when positioned in one of the storage positions, such as the folded position, the tumble position or the further rotation position, discussed above. The storage space may also include the space need for the rear seat assembly 14 to travel between the locked position and one of the storage positions without causing interference between the front seat assembly 12 and the rear seat assembly 14 along a path of travel of the rear seat assembly 14.

In block 112, the seat controller 40 determines the position of the front seat assembly 12. The seat controller 40 receives inputs from the sensors 28 indicating the angle of recline rearward of the seat back 22 and the fore-aft position of the seat bottom 16. Based on the position of the front seat assembly 12, including the recline angle of the seat back 22 and fore-aft position of the seat bottom 16, the seat controller 40 may determine the amount of required storage space for the rear seat assembly 14 when is moves to the folded position 84 and/or tumble position 96.

In step 114, the seat controller 40 determines if the position of the front seat assembly 12 is acceptable based on requested storage space of the rear seat assembly 14. The seat controller 40 compares the requested storage space to the currently provided storage space. If the currently provided storage space is greater than the requested storage space, no adjustment of the front seat assembly 12 is needed, as indicated in block 116. But if the currently provided storage space is less than the required storage space, the front seat assembly 12 may be automatically adjusted to a storage accommodation position.

In another embodiment, if the currently provided storage space is less than the required storage space, the controller 40 may also determine if moving the head restraint 34 of the rear seat assembly 14 to a folded position 98 would reduce the requested storage space of the rear seat assembly 14. If folding the head restraint 34 to the folded position 98 makes the required storage space less than the required storage space, then the controller 40 may automatically adjust the head restraint 34 to its folded position, as shown in FIG. 2. As shown in FIG. 3, the head restraint 34 may be moved to the folded position as part of moving the rear seat assembly 14 to the tumbled position 96.

Prior to adjusting the front seat assembly 12, the seat controller 40 notifies the occupants of the recommended seat adjustment via the interface 50, as shown in block 118. The occupants may decline or accept the recommended seat adjustment via the interface 50. The seat controller 40 may also receive input that the front seat is occupied via a vehicle seat occupancy switch or front occupant data input via the interface 50. The seat controller 40 may prevent actuation of the front seat assembly 12 to the accommodation position when the front seat assembly 12 is occupied by a passenger. The seat controller 40 may also ensure that the vehicle is parked or not moving before initiating the recommended seat adjustment to the accommodation position.

In block 120, the front seat assembly 12 is adjusted to provide adequate storage space for the rear seat assembly 14 when it is moved to the storage positions. The seat controller 40 conveys a signal to the actuators 28 with instructions to move the seat to the accommodation position 52. To move the seat to the accommodation position, the seat controller 40 conveys a signal to the actuators 28 to pivot the seat back 22 forward in a direction of arrow A and/or to move the seat 12 in the fore-aft direction along arrow B. The accommodation position may also include rotating the rear head restraint 34 to the stowed position 98.

After the front seat assembly 12 and/or the rear seat assembly are moved to the accommodation positions, the rear seat assembly 14 can be moved to its requested storage position, as shown in block 122. If the folded storage position 84 is requested, as shown in FIG. 2, the seat controller 40 conveys a signal to the actuator 38 with instructions to move the seat to the folded position 84. To move the seat to the folded position 84, the seat controller 40 conveys a signal to the actuator 38 to unlock the seat back 32 from the upright position and pivot the seat back 32 forward to rest on the seat bottom 30.

If the tumbled storage position is requested, as shown in FIG. 3, the seat controller 40 conveys a signal to the actuator 60 with instructions to move the seat to the tumbled position 96. To move the seat to the tumbled position 96, the seat controller 40 conveys a signal to the actuator 60 to release the latch 64 from the striker 68 and then pivot the seat bottom 30 forward about the pivot point 66.

The various seat assembly controllers from the various embodiments may be embodied in a module within the corresponding seat assembly, or any controller; each of which may generally include any number of microprocessors, ASICs, ICs, memory (e.g., FLASH, ROM, RAM, EPROM, and/or EEPROM) which co-act with software code to perform the operations.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A vehicle seat controller programmed to:
receive a request to move a rear seat to a storage position;
determine a current storage space based on a position of a front seat;
determine a requested storage space based on the storage position;
provide a signal to an actuator to move the front seat to an accommodation position when the requested storage space is less than the current storage space.

2. A vehicle seating assembly comprising:
a front seat assembly comprising:
a front seat bottom mounted to the vehicle body;
a front seat back mounted to the vehicle body adjacent to the front seat bottom;
a sensor cooperating with at least one of the front seat bottom and the front seat back;
an actuator disposed on at least one of the seat bottom and seat back; and
a rear seat assembly behind the front seat assembly movable to the storage position, the rear seat assembly comprising:
a rear seat bottom pivotally mounted to the vehicle body;
a rear seat back mounted to move relative to the rear seat bottom; and
a vehicle seat controller according to claim 1 in communication with the sensor and the actuator.

3. The vehicle seat assembly of claim 2 wherein the storage position comprises folding a rear seat back toward a rear seat bottom to a folded storage position.

4. The vehicle seat assembly of claim 3 wherein the storage position comprises pivoting the rear seat bottom in relation to the vehicle body to move the rear seat assembly from the folded storage position to a tumbled storage position.

5. The vehicle seat assembly of claim 4 wherein the front seat assembly moves to a first accommodation position when the rear seat assembly is requested to move to the folded position, and the front seat assembly moves to a second accommodation position when the rear seat assembly is requested to move to the tumbled position.

6. The vehicle seat assembly of claim 2 wherein the accommodation position decreases at least one of a reclined angle of the front seat back and a fore-aft position of the front seat bottom to increase the current storage space.

7. The vehicle seat assembly of claim 2 wherein the controller is further programmed to provide a signal to the rear seat to rotate a rear head restraint toward the rear seatback to decrease the requested storage space.

8. The vehicle seat assembly of claim 2 further comprising an interface in communication with the controller for inputting the requested storage position.

9. The vehicle seat assembly of claim 2 wherein the interface comprises at least one switch disposed adjacent a tailgate of the vehicle.

10. A vehicle seat controller configured to:
receive an input indicative of a request to move a rear seat assembly to a storage position;
command a first actuator to move a front seat assembly to an accommodation position in response to the input; and
command to a second actuator to move the rear seat assembly to the storage position.

11. A vehicle seating assembly comprising:
a front seat assembly comprising:
a front seat bottom;
a front seat back mounted adjacent to the front seat bottom;
a sensor cooperating with at least one of the front seat bottom and the front seat back;
an actuator disposed on at least one of the seat bottom and seat back; and
a rear seat assembly behind the front seat assembly;
a vehicle seat controller according to claim 10 in communication with the sensor and the actuator.

12. The vehicle seat assembly of claim 11 wherein the storage position comprises folding a rear seat back toward a rear seat bottom to a folded storage position.

13. The vehicle seat assembly of claim 11 wherein the storage position comprises pivoting the rear seat assembly from the folded storage position to a tumbled storage position.

14. The vehicle seat assembly of claim 11 further comprising an interface in communication with the controller for receiving the input of the requested storage position.

15. The vehicle seat assembly of claim 11 wherein the interface comprises at least one switch located remote from the rear seat assembly.

16. The vehicle seat assembly of claim 11 further comprising a rear seat actuator for moving the rear seat assembly to the storage position after the front seat assembly is moved to the accommodation position.

17. A method for controlling a seat assembly having a front seat and a rear seat positioned rearward of the front seat, the method comprising:
receiving a first input indicating a requested storage position of a rear seat;
commanding a first actuator to move the front seat an accommodation position in response to the first input; and
commanding a second actuator to move the rear seat to the storage position after the front seat is moved to the accommodation position.

18. The method of claim 17 further comprising:
receiving a second input indicating a position of the front seat;
determining a requested storage space based on the second input;
determining a current storage space based on the second input; and
commanding the first actuator to move at least one of the front seat and rear seat to the accommodation position when the requested storage space is less than the current storage space.

19. The method of claim 17 further comprising moving the front seat to the accommodation position by decreasing at least one of a reclined angle of a front seat back and a fore-aft position of a front seat bottom to increase the current storage space.

20. The method of claim 17 further comprising moving the front seat to the accommodation position by rotating a rear head restraint toward a rear seat back to decrease the requested storage space.
